(19) United States
(12) Patent Application Publication
(10) Pub. No.: US 2025/0035454 A1
(43) Pub. Date: Jan. 30, 2025

(54) METHOD FOR RECOMMENDING MISSION DESTINATION USING URBAN DATA, AND APPARATUS FOR IMPLEMENTING THE SAME

(71) Applicant: MOTOV CO., LTD., Incheon (KR)

(72) Inventors: Seong Hoon KIM, Sejong-si (KR); Woo Hyeok LIM, Seoul (KR); Nam Young HEO, Chuncheon-si (KR)

(73) Assignee: MOTOV CO., LTD., Incheon (KR)

(21) Appl. No.: 18/587,083

(22) Filed: Feb. 26, 2024

(30) Foreign Application Priority Data
Jul. 28, 2023 (KR) 10-2023-0098567

(51) Int. Cl. G01C 21/34; G01C 21/00

(52) U.S. Cl. CPC G01C 21/3476; G01C 21/3815

(57) ABSTRACT

The present disclosure according to at least one embodiment provides a method for recommending a mission destination using urban data, the method being performed by a computing apparatus. The method comprises collecting urban data measured on a road partitioned into a plurality of unit areas, and generating a recommended destination for a mission vehicle based on the urban data and constraints set for performing a mission, wherein the recommended destination refers to one of the unit areas, and the mission is any one of a plurality of predetermined types of missions performed by the mission vehicle on a mission area on the road including the recommended destination and one or more adjacent areas of the recommended destination.

### CROSS-REFERENCE TO RELATED APPLICATION

This application claims priority from Korean Patent Application No. 10-2023-0098567 filed on Jul. 28, 2023 in the Korean Intellectual Property Office, and all the benefits accruing therefrom under 35 U.S.C. 119, the contents of which in its entirety are herein incorporated by reference.

### BACKGROUND

### 1. Technical Field

The present disclosure relates to a method for recommending a mission destination using urban data, and an apparatus for implementing the same, and more particularly, to a method for recommending a mission destination using urban data for providing a service that generates a destination to perform a mission for urban environment control, and an apparatus for implementing the same.

### 2. Description of the Related Art

Recently, interest in urban environment control has increased in order to improve atmospheric environmental pollution of a city caused by fine dust, harmful gases, odors, and the like.

Conventionally, an effort to reduce the fine dust by installing sensors at designated places of a city to measure, for example, fine dust concentrations, and deploying a sprinkler truck to a region having a high fine dust pollution level based on the measured fine dust concentrations has been made.

However, even in the same region in an administrative district, fine dust concentrations on roads vary sensitively depending on whether or not each road is under construction, the number and a type of vehicles traveling on each road, and the like, and it is thus difficult to obtain accurate data for urban environment control by a conventional method.

Due to such difficulty in securing accurate atmospheric environment measurement data, the urban environment control has been implemented in the form of arbitrarily designating a mission destination and making the sprinkler truck visit the mission destination when the sprinkler truck for removing the fine dust travels.

However, such a method of arbitrarily designating the mission destination is inefficient in terms of fuel consumption, time utilization, and the like, of a mission vehicle such as the sprinkler truck.

In addition, when the mission destination is arbitrarily designated without any consideration of information on road surface conditions of the roads, illegal advertisements in the city, demonstrations/events in the city, and the like, an obstacle in performing the mission, such as a situation in which the time required for the mission vehicle to reach the mission destination becomes longer than an expected time or a situation in which it is difficult for the mission vehicle to reach the mission destination may occur.

Further, conventionally, a service that provides the shortest route to the mission destination in consideration of traffic situations when a user or an administrator arbitrarily inputs the mission destination has been provided, but a method for recommending the mission destination itself using accurate atmospheric environment measurement data has not been disclosed.

Accordingly, it is necessary to secure accurate atmospheric environment measurement data at a road level subdivided more than an administrative district level, and it is also necessary to secure state-related data of the city, such as the information on the road surface conditions of the roads, the illegal advertisements in the city, the demonstrations/events in the city, and the like. In addition, technology that provides the mission destination appropriate for a situation in consideration of the atmospheric environment measurement data of the city and the state-related data of the city secured as described above, and other environmental constraints has been demanded.

### SUMMARY

Aspects of the present disclosure provide a method for recommending a mission destination using urban data that may be utilized for urban environment control by collecting urban data in space-time units divided into unit areas of a road and time zones, and an apparatus for implementing the same.

Aspects of the present disclosure also provide a method for recommending a mission destination using urban data capable of recommending a mission destination that a mission vehicle should visit using urban data collected in space-time units and other environmental constraints, and an apparatus for implementing the same.

Aspects of the present disclosure also provide a method for recommending a mission destination using urban data capable of automatically generating mission destinations using urban data based on an artificial intelligence model for a single vehicle or a plurality of vehicles performing missions for urban environment control, and an apparatus for implementing the same.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to an aspect of the present disclosure, there is provided a method for recommending a mission destination using urban data, the method being performed by a computing apparatus. The method comprises collecting urban data measured on a road partitioned into a plurality of unit areas, and generating a recommended destination for a mission vehicle based on the urban data and constraints set for performing a mission, wherein the recommended destination refers to one of the unit areas, and the mission is any one of a plurality of predetermined types of missions performed by the mission vehicle on a mission area on the road including the recommended destination and one or more adjacent areas of the recommended destination.

In some embodiments, the collecting of the urban data may include collecting the urban data in space-time units divided into the plurality of unit areas and a plurality of time zones.

In some embodiments, the collecting of the urban data may include performing processing on a missing value when collecting the urban data corresponding to each of the plurality of unit areas and the plurality of time zones.

In some embodiments, the collecting of the urban data may include obtaining the urban data measured by a fixed sensor installed on the road or around the road, and the urban data may be measured at a preset period using the fixed sensor on a road on which a sampling target value is a reference value or more.

In some embodiments, the collecting of the urban data may include obtaining the urban data measured by a mobile sensor installed in a mobility traveling on the road, and the urban data may be measured using the mobile sensor on a road on which a sampling target value is less than a reference value.

In some embodiments, the collecting of the urban data may include transmitting a provision request for the urban data to a mobile terminal or an Internet of Things (IoT) terminal located on the road or around the road, and obtaining the urban data measured by a sensor mounted in the mobile terminal or the IoT terminal.

In some embodiments, the constraints may include at least one of a mission performance time, whether or not start/end times are punctual, an urgency level, and whether or not departure/destination places match, and the generating of the recommended destination for the mission vehicle may include outputting the recommended destination by applying the urban data and the constraints to an artificial intelligence algorithm.

In some embodiments, the outputting of the recommended destination may include outputting a plurality of recommended destinations corresponding to a single mission vehicle together with visit order information when the number of mission vehicles is one, and outputting a control signal so that the single mission vehicle continuously visits the plurality of recommended destinations based on the visit order information.

In some embodiments, the outputting of the recommended destination may include outputting a plurality of recommended destinations corresponding to a single mission vehicle together with visit time information when the number of mission vehicles is one, and outputting a control signal so that the single mission vehicle visits each of the recommended destinations n times (where n is a natural number) based on the visit time information.

In some embodiments, the outputting of the plurality of recommended destinations corresponding to the single mission vehicle together with the visit time information may include generating destination groups by classifying the mission destinations by regional groups, determining recommended destinations corresponding to the single mission vehicle for each destination group, and outputting the recommended destinations determined for each destination group together with the visit time information.

In some embodiments, the outputting of the recommended destination may include assigning corresponding recommended destinations to each of a plurality of mission vehicles when the number of mission vehicles is plural, and extracting visit patrol routes for each of the plurality of mission vehicles based on the assigned recommended destinations, and the recommended destinations may be assigned so as not to overlap each other between the plurality of mission vehicles.

In some embodiments, the assigning of the corresponding recommended destinations to each of the plurality of mission vehicles may include assigning the recommended destinations using management district information of each of the plurality of mission vehicles.

In some embodiments, the assigning of the corresponding recommended destinations to each of the plurality of mission vehicles may include assigning the recommended destinations using travel time information of each of the plurality of mission vehicles.

In some embodiments, the method further may comprise outputting a control signal so that a following vehicle mounted with a mobile sensor visits the recommended destination and measures the urban data while each mission vehicle visits the assigned recommended destination and performs the mission, and determining whether or not each mission vehicle performs the mission at the assigned recommended destination based on whether or not a measured value of the urban data measured by the mobile sensor of the following vehicle is within a target range.

In some embodiments, the extracting of the visit patrol routes for each of the plurality of mission vehicles based on the assigned recommended destinations may include extracting the visit patrol routes using at least one of a traffic congestion degree, whether or not an event has occurred, whether or not there is a high concentration of fine dust, and whether or not data collection missions are performed simultaneously.

In some embodiments, the outputting of the recommended destination may include configuring a plurality of features included in the urban data in a plurality of layers, performing scaling on two or more layers selected from the plurality of layers, outputting information on the recommended destination from a result of performing the artificial intelligence algorithm using the two or more layers on which the scaling is performed as inputs, and generating a visit patrol route for the mission vehicle to move to the recommended destination using the information on the recommended destination.

In some embodiments, the method may further comprise obtaining scoring data by calculating a score for an environmental situation for each road using the plurality of layers, and outputting a control signal so that the mission vehicle located in another region moves to the mission destination when it is decided that the number of mission vehicles located at the mission destination is less than a reference value based on the scoring data.

According to the aforementioned and other embodiments of the present disclosure, there is provided a computing apparatus. The computing apparatus comprises one or more processors, a memory loading a computer program executed by the processor, and a storage storing the computer program, wherein the computer program includes instructions for performing an operation of collecting urban data measured on a road partitioned into a plurality of unit areas, and an operation of generating a recommended destination for a mission vehicle based on the urban data and constraints set for performing a mission, the recommended destination refers to one of the unit areas, and the mission is any one of a plurality of predetermined types of missions performed by the mission vehicle on a mission area on the road including the recommended destination and one or more adjacent areas of the recommended destination.

In some embodiments, the constraints may include at least one of a mission performance time, whether or not start/end times are punctual, an urgency level, and whether or not departure/destination places match, and the operation of generating the recommended destination for the mission vehicle may include an operation of outputting the recommended destination by applying the urban data and the constraints to an artificial intelligence algorithm.

In some embodiments, the operation of outputting the recommended destination may include an operation of outputting a plurality of recommended destinations corresponding to a single mission vehicle together with visit order information when the number of mission vehicles is one, and an operation of outputting a control signal so that the single mission vehicle continuously visits the plurality of recommended destinations based on the visit order information.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a flowchart for describing a method for recommending a mission destination using urban data performed by a computing apparatus according to an exemplary embodiment of the present disclosure;

FIGS. 2 and 3 are flowcharts for describing detailed processes of some steps of the method illustrated in FIG. 1;

FIG. 4 is a flowchart illustrating some of the detailed processes illustrated in FIG. 3;

FIG. 5 is a flowchart illustrating steps additionally performed after the steps illustrated in FIG. 4;

FIG. 6 is a diagram illustrating an example of outputting a recommended destination by applying urban data and constraints to an artificial intelligence algorithm according to some exemplary embodiments of the present disclosure;

FIG. 7 is a diagram illustrating an example of generating recommended mission destinations for a single vehicle according to some exemplary embodiments of the present disclosure;

FIG. 8 is a diagram illustrating an example of generating recommended mission destinations for each of a plurality of vehicles according to some exemplary embodiments of the present disclosure;

FIG. 9 is a diagram illustrating an example of assigning recommended mission destinations so as to avoid overlap between a plurality of vehicles according to some exemplary embodiments of the present disclosure;

FIG. 10 is a diagram illustrating an example of generating recommended destinations for each unit area of a road and each time zone for a single vehicle according to some exemplary embodiments of the present disclosure;

FIG. 11 is a diagram illustrating an example of generating recommended destinations based on management districts and travel time information for a plurality of vehicles according to some exemplary embodiments of the present disclosure; and

FIG. 12 is a hardware configuration diagram of an illustrative computing apparatus capable of implementing methods according to an exemplary embodiment of the present disclosure.

### DETAILED DESCRIPTION OF THE EMBODIMENTS

Hereinafter, preferred embodiments of the present disclosure will be described with reference to the attached drawings. The advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Hereinafter, some embodiments of the present disclosure will be described in detail with reference to the accompanying drawings.

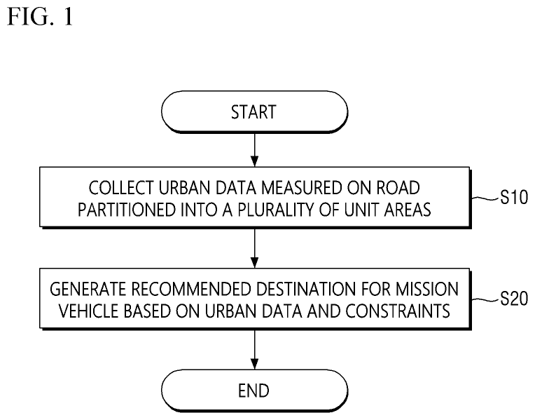

FIG. 1 is a flowchart for describing a method for recommending a mission destination using urban data performed by a computing apparatus according to an exemplary embodiment of the present disclosure.

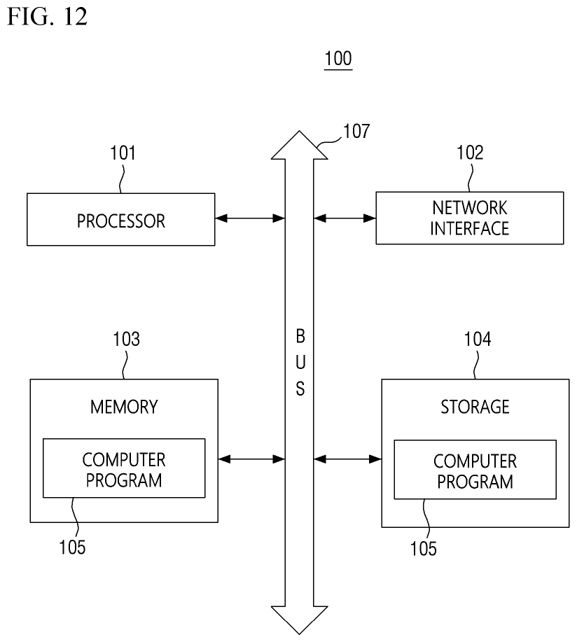

A method for recommending a mission destination using urban data according to an exemplary embodiment of the present disclosure may be performed by a computing apparatus 100 illustrated in FIG. 12. The computing apparatus 100 may be an apparatus capable of performing a computational function, such as a server or a personal computer (PC).

It is to be noted that a description of a subject performing some operations included in the method according to an exemplary embodiment of the present disclosure may be omitted, and in such a case, the subject is the computing apparatus 100.

Referring to FIG. 1, first, in operation S10, the computing apparatus 100 collects urban data measured on a road partitioned into a plurality of unit areas. The urban data may be data that may be measured using an air quality measurement sensor and is obtained by measuring a pollution degree of an atmospheric environment such as fine dust, harmful gases, and odors. In addition, the urban data may be data that may be measured using a camera sensor and is obtained by capturing images of road surface conditions (potholes, tracks, etc.) of the road, illegal parking, illegal banners, illegal outdoor billboards, and the like. Further, the urban data may be data that may be measured using a sound sensor and is obtained by measuring noise decibels due to events, demonstrations, or the like. The urban data is not limited to the types of data described above, and may include all data that may be measured using sensors in relation to environmental factors of the city.

As an example, the computing apparatus 100 may collect the urban data in space-time units divided into a plurality of unit areas and a plurality of time zones. Here, the plurality of unit areas may be areas divided into spaces in road or lattice units in consideration of directionality through a map matching process after correcting a location by applying a Kalman filter to the road. In addition, the plurality of time zones may be time zones divided into minutes, hours, or the like. Accordingly, the urban data may be collected in block units of a time and a space divided using the unit areas of the road and the time zones.

Meanwhile, when the computing apparatus 100 collects the urban data for each of the space-time units corresponding to the plurality of unit areas and the plurality of time zones, a missing value may occur in a specific unit area and a specific time zone. When a ratio of the missing value to all data is not great, even though the missing value is imputed to a mean, a constant, or the like, the missing value may not have a significant influence on a distribution of the data, but when the ratio of the missing value to all data is great, the missing value may have an influence on the distribution of the data and a correlation between variables.

Accordingly, in order to minimize the influence of the missing value on the distribution of all data, the computing apparatus 100 may perform processing such as interpolation or imputation on the missing value in the specific unit area and the specific time zone among the collected urban data. In this case, the interpolation for the missing value may be performed using a prediction result of the missing value based on an artificial intelligence (AI) algorithm. In addition, the imputation for the missing value may be performed by imputing the missing value to, for example, a mean, a median, a mode, or a specific constant of the data.

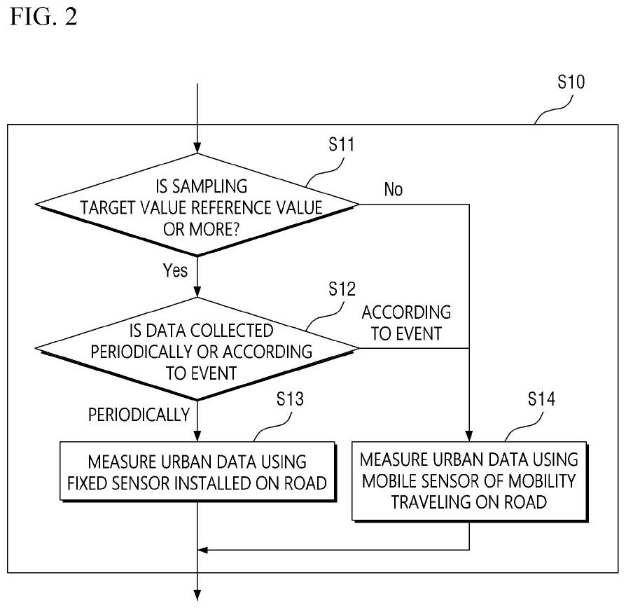

As an example, referring to FIG. 2, operation S10 may include operations S11 to S14, which are detailed operations.

The computing apparatus 100 may decide whether or not the road is a road on which a sampling target value is a reference value or more in operation S11 in collecting the urban data, and decide whether to collect the data periodically or according to an event in operation S12 when the road is the road on which the sampling target value is the reference value or more.

When the periodical collection of the data is required as a result of the decision in operation S12, the computing apparatus 100 may obtain urban data measured by a fixed sensor installed on the road or around the road in operation S13. As an example, the computing apparatus 100 may measure urban data at a preset period (e.g., every 30 minutes, every hour, every 3 hours, etc.) using the fixed sensor.

In addition, when the collection of the data according to the event is required as a result of the decision in operation S12, the computing apparatus 100 may obtain urban data measured by a mobile sensor installed in a mobility traveling on the road in operation S14. As an example, the computing apparatus 100 may collect measured values of fine dust using a mobile sensor installed in the mobility traveling on Olympic highway between 18:00 and 19:00 based on location information of the mobility in order to measure a fine dust level between 18:00 and 19:00 on Olympic highway where a fine dust concentration is expected to increase due to an increase in vehicles caused by a specific event.

In addition, operation S14 in which urban data is measured by the mobile sensor of the mobility traveling on the road may also be performed when the road is a road on which the sampling target value is less than the reference value.

As an example, when the computing apparatus 100 collects the urban data, a mobile terminal of a passerby standing around the road or moving on foot or in a vehicle may be used. In addition, the Internet of Things (IoT) terminal installed in a building or an outdoor electronic signboard of the city may be used in order to collect the urban data.

As an example, the computing apparatus 100 may transmit a provision request signal for the urban data to the mobile terminal or the IoT terminal located on the road or around the road, and obtain the urban data measured by the mobile terminal or the IoT terminal when there is approval from the mobile terminal or the IoT terminal that has received the provision request signal.

Next, in operation S20 of FIG. 1, the computing apparatus 100 generates a recommended destination for a mission vehicle based on the urban data and constraints set in order to perform a mission. The mission vehicle is a mobile vehicle capable of performing a mission related to urban environment control or collection of the urban data, and may be, for example, a sprinkler truck, a road cleaning vehicle, a mobility mounted with a fine dust measurement sensor and a camera sensor, an illegal parking enforcement vehicle, or the like. The recommended destination may refer to one of the plurality of unit areas of the road. In addition, the mission may be performed by the mission vehicle on a mission area on the road that includes the recommended destination and one or more adjacent areas of the recommended destination. In addition, the mission may be any one of a plurality of predetermined types of missions performed by the mission vehicle.

As an example, the plurality of types of missions performed by the mission vehicle may be, for example, fine dust removal, road cleaning, illegal parking enforcement, illegal banner enforcement, road surface maintenance of the road, urban data collection, and the like.

Meanwhile, the plurality of types of missions performed by the mission vehicle may be missions related to services to be applied to a future vehicle. As an example, in the field of a public service using the future vehicle, as missions for user convenience, missions such as transportation vulnerable movement support, optimization of public transportation, and a shared car service may be performed In addition, as missions for making an urban function efficient, missions such as autonomous driving public administration, a road emergency recovery service, and emergency response at the time of vehicle breakdown may be performed. In addition, as missions for a public safety service, missions such as day and night monitoring, emergency vehicle traffic support, and autonomous driving patrol may be performed.

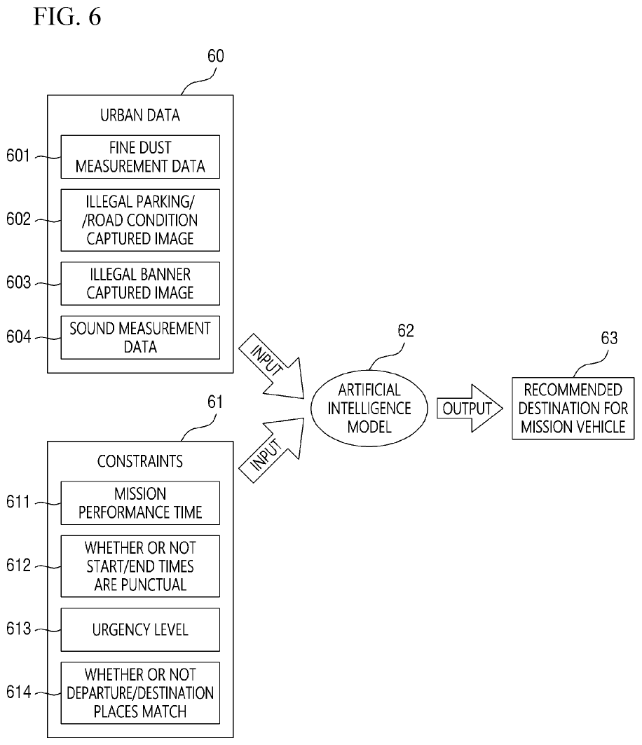

As an example, in an example illustrated in FIG. 6, the computing apparatus 100 may input urban data 60 and constraints 61 to an artificial intelligence model 62 and output a recommended destination 63 for the mission vehicle. In this case, the urban data 60 may include, for example, fine dust measurement data 601, an illegal parking/road condition captured image 602, an illegal banner captured image 603, and sound measurement data 604. The constraints 61 may include a mission performance time 611, whether or not start/end times are punctual 612, an urgency level 613, and whether or not departure/destination places match 614.

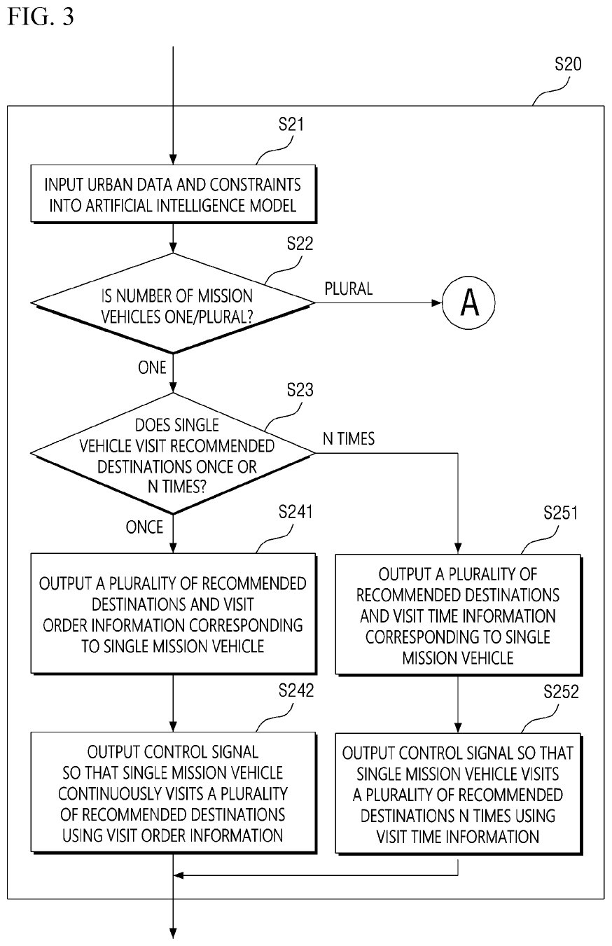

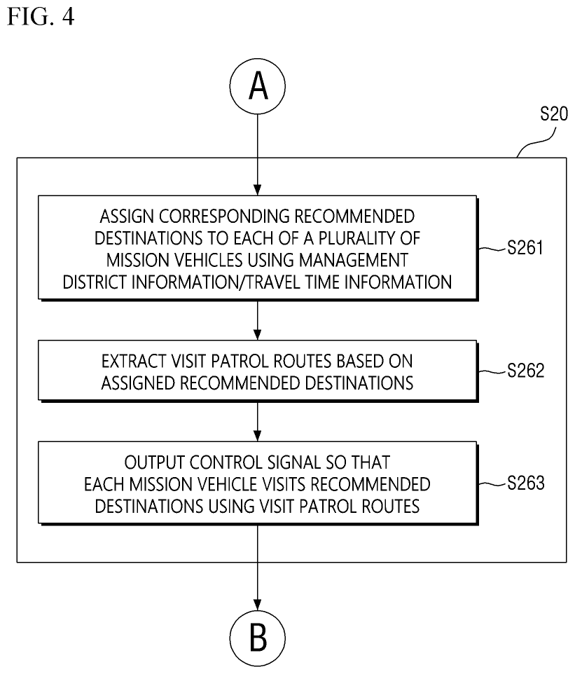

As an example, referring to FIGS. 3 and 4, operation S20 may include operations S21 to S252 and operations S261 to S263, which are detailed operations.

In operation S21, the computing apparatus 100 may input the urban data and the constraints into the artificial intelligence model. Here, an optimal model for solving a vehicle routing problem (VRP), such as a heuristic model, reinforcement learning, or a neural combinatorial optimization solver, may be used as an artificial intelligence model.

The heuristic model is applied to a complex problem whose decision rule for an optimal solution may not be obtained, and refers to a decision model using an empirical rule or knowledge, that is, a heuristic, that shortens the time required to obtain a satisfactory solution even though it is not guaranteed to obtain the optimal solution. The reinforcement learning is learning what action is an optimal action to be taken in a current state, and learning is performed in a manner of giving a reward from an external environment whenever an action is taken and maximizing such a reward. The neural combinatorial optimization solver is to solve a combinatorial optimization problem using deep learning, the combinatorial optimization problem is a problem of finding an optimal solution in a finite search space, and the search space may be usually expressed to be discrete.

Next, it may be decided whether the number of mission vehicles is one or plural in operation S22, and when it is decided that the number of mission vehicles is one, it may be decided whether a single vehicle will visit all of a plurality of recommended destinations once or n times (n is a natural number of 2 or more) in operation S23.

In this case, when the single vehicle should visit the plurality of recommended destinations once as a result of the decision in operation S23, the computing apparatus 100 may output the plurality of recommended destinations and visit order information corresponding to a single mission vehicle in operation S241. Next, in operation S242, the computing apparatus 100 may output a control signal so that the single mission vehicle continuously visits the plurality of recommended destinations using the visit order information.

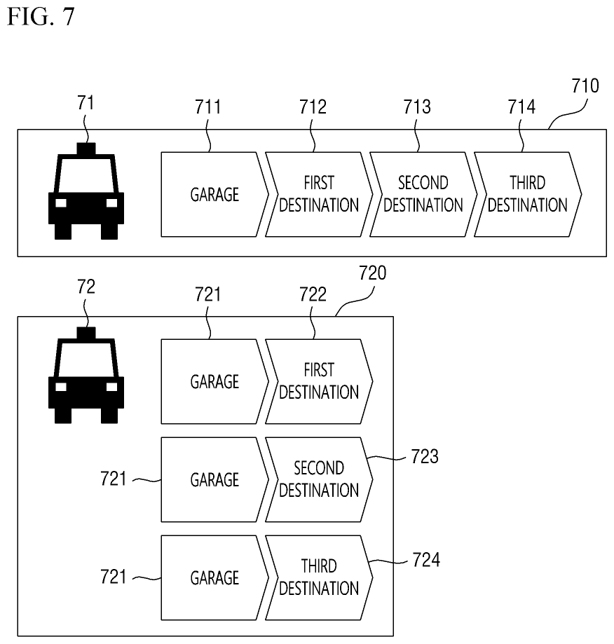

As an example, in an example 710 illustrated in FIG. 7, the computing apparatus 100 may output a first destination 712, a second destination 713, and a third destination 714 that a single vehicle 71 located in a garage 711 should continuously visit as recommended destinations for the single vehicle 71, and may also output numerical information indicating visit order.

In addition, when the single vehicle should visit the plurality of recommended destinations n times as a result of the decision in operation S23, the computing apparatus 100 may output the plurality of recommended destinations and visit time information corresponding to the single mission vehicle in operation S251. Next, in operation S252, the computing apparatus 100 may output a control signal so that the single mission vehicle visits the plurality of recommended destinations n times using the visit time information.

As an example, in an example 720 illustrated in FIG. 7, the computing apparatus 100 may output a first destination 722, a second destination 723, and a third destination 724 that a single vehicle 72 located in a garage 721 should visit discontinuously three times as recommended destinations for the single vehicle 72, and may also output time zone information indicating time zones in which the single vehicle 72 should visit the first destination 722, the second destination 723, and the third destination 724. In this case, when the single vehicle 72 visits the first destination 722, the second destination 723, and the third destination 724 discontinuously three times, a duplicate visit of the single vehicle 72 to the garage 721, which is an intermediate stopover, may be permitted.

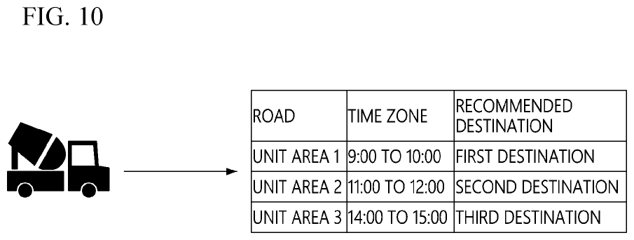

As an example, as illustrated in FIG. 10, the computing apparatus 100 may output information on recommended destinations including unit areas of a road and time zones where a mission is to be performed, for the single vehicle.

As an example, when the single vehicle should visit a plurality of recommended destinations n times, the computing apparatus 100 may generate a plurality of destination groups by classifying mission destinations by regional groups, and determine recommended destinations corresponding to the single vehicle for each destination group. In this case, the computing apparatus 100 may output the recommended destinations and the visit time information so that the single vehicle may visit the recommended destinations determined for each destination group and perform the mission.

On the other hand, when it is decided that the number of mission vehicles is plural in operation S22, the computing apparatus 100 may assign corresponding recommended destinations to each of a plurality of mission vehicles in operation S261 of FIG. 4. In this case, the recommended destinations may be assigned using management district information and travel time information of each mission vehicle. The recommended destinations may be assigned so as not to overlap each other between the plurality of mission vehicles.

Subsequently, the computing apparatus 100 may extract visit patrol routes for each of the plurality of mission vehicles based on the assigned recommended destinations in operation S262, and output a control signal so that each mission vehicle visits the recommended destinations using the extracted visit patrol routes in operation S263. In this case, the visit patrol routes may also be extracted so as not overlap each other between the plurality of mission vehicles. In this case, the visit patrol routes may be extracted using at least one of a traffic congestion degree, whether or not an event has occurred, whether or not there is a high concentration of fine dust, and whether or not data collection missions are performed simultaneously.

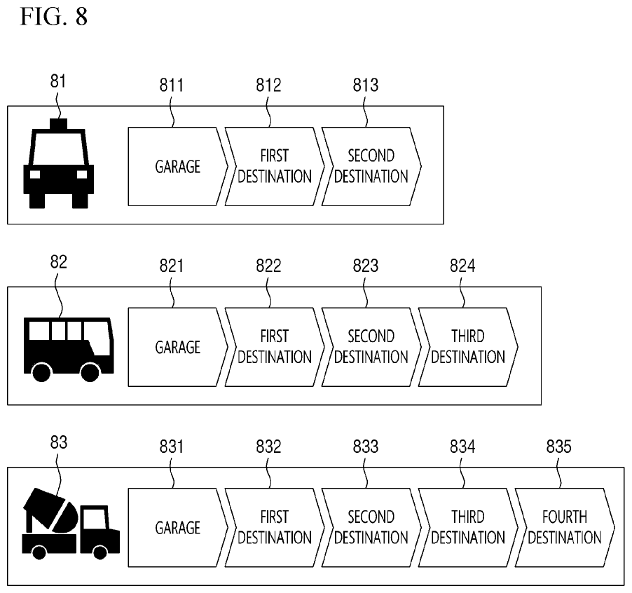

As an example, in an example illustrated in FIG. 8, the computing apparatus 100 may output a first destination 812 and a second destination 813 that a first mission vehicle 81 located in a garage 811 should continuously visit as recommended destinations for the first mission vehicle 81, and output a first destination 822, a second destination 823, and a third destination 824 that a second mission vehicle 82 located in a garage 821 should continuously visit as recommended destinations for the second mission vehicle 82. In addition, the computing apparatus 100 may output a first destination 832, a second destination 833, a third destination 834, and a fourth destination 835 that a third mission vehicle 83 located in a garage 831 should continuously visit as recommended destinations for the third mission vehicle 83. In this case, the recommended destinations for each of the mission vehicles 81, 82, and 83 may be assigned in consideration of management district information and travel time information of each of the mission vehicles.

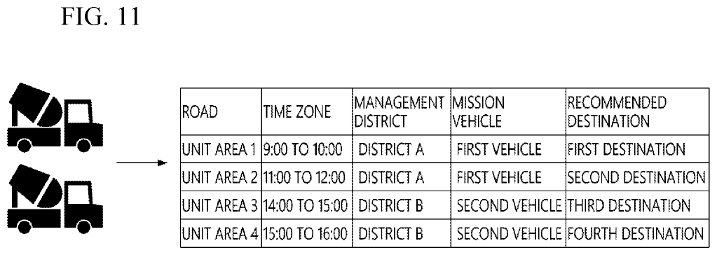

As an example, as illustrated in FIG. 11, the computing apparatus 100 may output information on recommended destinations including unit areas of a road and time zones where missions are to be performed, using the management district information and the travel time information of each mission vehicle, for each of the plurality of vehicles.

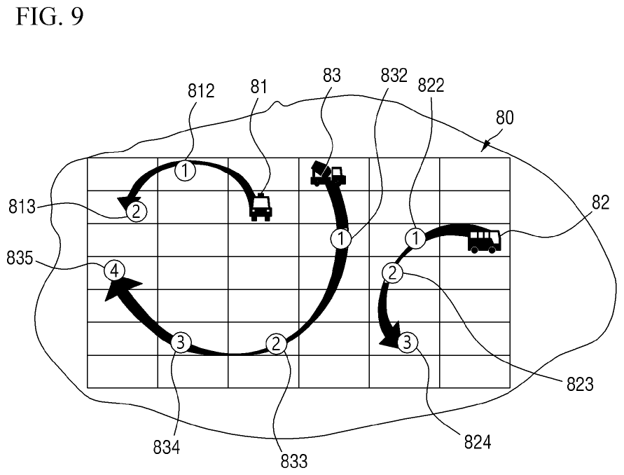

As an example, as in an example illustrated in FIG. 9, the computing apparatus 100 may extract visit patrol routes for visiting a plurality of destinations for each of the plurality of mission vehicles 81, 82, and 83 output in FIG. 8, and display the extracted visit patrol routes through a screen interface.

In the example illustrated in FIG. 9, the computing apparatus 100 may display a road 80 partitioned into a plurality of unit areas through the screen interface, and display the destinations 812 and 813 assigned to the first mission vehicle 81 and a visit patrol route connecting the destinations 812 and 813 to each other on the road 80. Likewise, the computing apparatus 100 may display a visit patrol route connecting the destinations 822, 823, and 824 assigned to the second mission vehicle 82 to each other and a visit patrol route connecting the destinations 832, 833, 834, and 835 assigned to the third mission vehicle 83 to each other. In this case, the visit patrol routes for each of the plurality of mission vehicles 81, 82, and 83 may be extracted and displayed so as not to overlap each other between the plurality of mission vehicles 81, 82, and 83.

As described above, according to an exemplary embodiment of the present disclosure, it is possible to provide optimal mission destinations and visit patrol routes for reaching the optimal mission destinations to the single vehicle or the plurality of vehicles performing missions for urban environment control, based on the artificial intelligence algorithm, in consideration of atmospheric conditions around the road in each time zone, illegal parking on the road, road conditions, demonstrations and events around the road, and the like. In addition, it is possible to recommend the mission destinations to each of the plurality of vehicles performing the missions so that the mission destinations do not overlap each other, in consideration of management districts and travel times of each vehicle.

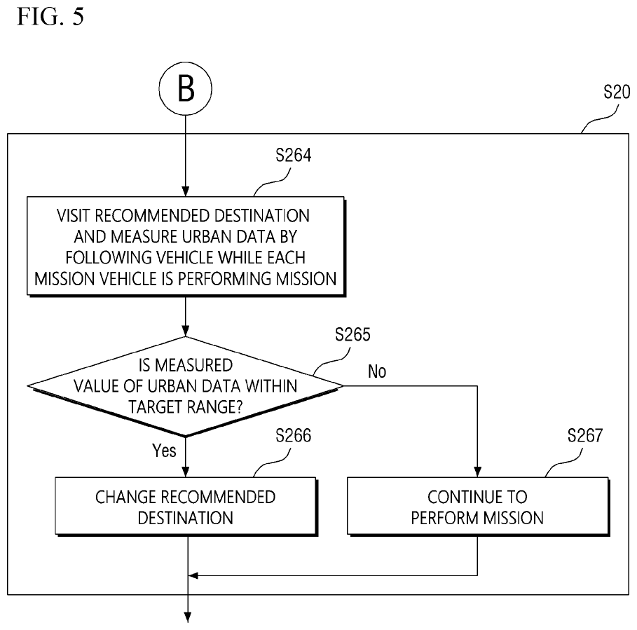

As an example, as illustrated in FIG. 5, operations S264 to S267 may be further performed as additional operations after operations S261 to S263 illustrated in FIG. 4 are performed.

In operation S264, the computing apparatus 100 may output a control signal so that the following vehicle mounted with a mobile sensor visits the recommended destination and measures urban data while each mission vehicle is performing the mission.

Next, in operation S265, the computing apparatus 100 may decide whether or not a measured value of the urban data measured by the mobile sensor of the following vehicle is within a target range, and determine whether or not each mission vehicle will continue to perform the mission at the assigned recommended destination according to a result of the decision. Here, the following vehicle may be, for example, another mission vehicle mounted with a mobile sensor or a mobility mounted with a mobile sensor collecting urban data measured on the road.

When the measured value of the urban data measured by the following vehicle is within the target range as a result of the decision in operation S265, the computing apparatus 100 may change the recommended destination assigned to the mission vehicle in operation S266.

In addition, when the measured value of the urban data measured by the following vehicle is out of the target range as a result of the decision in operation S265, the computing apparatus 100 may output a control signal so that the mission vehicle continues to perform the mission at the recommended destination assigned to the mission vehicle in operation S267.

As an example, when a measured value of fine dust measured by the following vehicle is within a normal range while the sprinkler truck is removing fine dust from the road, the sprinkler truck may be assigned another mission destination without having to continue perform a fine dust removal mission on the road. When the measured value of the fine dust measured by the following vehicle is out of the normal range, the computing apparatus 100 may output a control signal so that the sprinkler truck continues to perform the fine dust removal mission on the road.

According to the exemplary embodiment as described above, it is possible to evaluate a mission performance level based on the measured value of the urban data measured by the following vehicle (another mission vehicle or a mobility collecting the urban data) while the mission vehicle is performing the mission at the recommended destination. Accordingly, rapid decision-making regarding whether the mission vehicle continues to perform the mission at the destination where the mission vehicle is performing the mission or moves to another destination and performs a mission at another destination may be made through collaboration with the following vehicle.

As an example, the computing apparatus 100 may generate the recommended destination using at least two of a plurality of features included in the urban data in outputting the recommended destination by applying the urban data and the constraints to the artificial intelligence algorithm.

Specifically, the computing apparatus 100 may configure the plurality of features included in the urban data in a plurality of layers, and perform scaling for making ranges of data equal to each other on two or more layers selected from the plurality of layers. Here, the scaling may be standardization processing for setting a mean of the data to 0 and setting a variance of the data to 1 or normalization processing for converting the range of the data between 0 and 1.

The computing apparatus 100 may output information on the recommended destination from a result of performing the artificial intelligence algorithm using the two or more layers on which the scaling is performed as described above as inputs. In addition, the computing apparatus 100 may generate a visit patrol route for the mission vehicle to move to the recommended destination using the information on the recommended destination.

As an example, the computing apparatus 100 may obtain scoring data by calculating a score for an environmental situation for each road using the plurality of layers composed of the plurality of features included in the urban data. In this case, when it is decided that the number of mission vehicles located at the mission destination is less than a reference value based on the obtained scoring data, the computing apparatus 100 may output a control signal so that a mission vehicle located in another region moves to the mission destination. As an example, when it is decided that the score for the environmental situation for each road is less than a reference value using the scoring data, the computing apparatus 100 may consider that there is a problem in an atmospheric environment on a road and control a vehicle located in another region to move to the road in order to increase the number of mission vehicles for improving the atmospheric environment on the road. As another example, when the sampling number of urban data required to calculate the scoring data is less than a reference value, the computing apparatus 100 may control a mobility mounted with a mobile sensor to move to the road and collect data.

FIG. 12 is a hardware configuration diagram of an exemplary computing device 100. Referring to FIG. 12, the computing device 100 may include one or more processors 101, a bus 107, a network interface 102, a memory 103, which loads a computer program 105 executed by the processors 101, and a storage 104 for storing the computer program 105.

The processor 101 controls overall operations of each component of computing device 100. The processor 101 may be configured to include at least one of a Central Processing Unit (CPU), a Micro Processor Unit (MPU), a Micro Controller Unit (MCU), a Graphics Processing Unit (GPU), or any type of processor well known in the art. Further, the processor 101 may perform calculations on at least one application or program for executing a method/operation according to various embodiments of the present disclosure. The computing device 100 may have one or more processors.

The memory 103 stores various data, instructions and/or information. The memory 103 may load one or more programs 105 from the storage 104 to execute methods/operations according to various embodiments of the present disclosure. An example of the memory 103 may be a RAM, but is not limited thereto.

The bus 107 provides communication between components of computing device 100. The bus 107 may be implemented as various types of bus such as an address bus, a data bus and a control bus.

The network interface 102 supports wired and wireless internet communication of the computing device 100. The network interface 102 may support various communication methods other than internet communication. To this end, the network interface 102 may be configured to comprise a communication module well known in the art of the present disclosure.

The storage 104 can non-temporarily store one or more computer programs 105. The storage 104 may be configured to comprise a non-volatile memory, such as a Read Only Memory (ROM), an Erasable Programmable ROM (EPROM), an Electrically Erasable Programmable ROM (EEPROM), a flash memory, a hard disk, a removable disk, or any type of computer readable recording medium well known in the art.

As an example, a computer program 105 may include instructions for performing an operation of collecting urban data measured on a road partitioned into a plurality of unit areas and an operation of generating a recommended destination for a mission vehicle based on the urban data and constraints set for performing a mission. In this case, the recommended destination may refer to one of the unit areas, and the mission may be any one of a plurality of predetermined types of missions performed by the mission vehicle on a mission area on the road including the recommended destination and one or more adjacent areas of the recommended destination.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation.

What is claimed is:

1. A method for recommending a mission destination using urban data, the method being performed by a computing apparatus, comprising:
collecting urban data measured on a road partitioned into a plurality of unit areas; and
generating a recommended destination for a mission vehicle based on the urban data and constraints set for performing a mission,
wherein the recommended destination refers to one of the unit areas, and
the mission is any one of a plurality of predetermined types of missions performed by the mission vehicle on a mission area on the road including the recommended destination and one or more adjacent areas of the recommended destination.

2. The method of claim 1, wherein the collecting of the urban data includes collecting the urban data in space-time units divided into the plurality of unit areas and a plurality of time zones.

3. The method of claim 2, wherein the collecting of the urban data includes performing processing on a missing value when collecting the urban data corresponding to each of the plurality of unit areas and the plurality of time zones.

4. The method of claim 1, wherein the collecting of the urban data includes obtaining the urban data measured by a fixed sensor installed on the road or around the road, and
the urban data is measured at a preset period using the fixed sensor on a road on which a sampling target value is a reference value or more.

5. The method of claim 1, wherein the collecting of the urban data includes obtaining the urban data measured by a mobile sensor installed in a mobility traveling on the road, and
the urban data is measured using the mobile sensor on a road on which a sampling target value is less than a reference value.

6. The method of claim 1, wherein the collecting of the urban data includes:
transmitting a provision request for the urban data to a mobile terminal or an Internet of Things (IoT) terminal located on the road or around the road; and
obtaining the urban data measured by a sensor mounted in the mobile terminal or the IoT terminal.

7. The method of claim 1, wherein the constraints include at least one of a mission performance time, whether or not start/end times are punctual, an urgency level, and whether or not departure/destination places match, and
the generating of the recommended destination for the mission vehicle includes outputting the recommended destination by applying the urban data and the constraints to an artificial intelligence algorithm.

8. The method of claim 7, wherein the outputting of the recommended destination includes:
outputting a plurality of recommended destinations corresponding to a single mission vehicle together with visit order information when the number of mission vehicles is one; and
outputting a control signal so that the single mission vehicle continuously visits the plurality of recommended destinations based on the visit order information.

9. The method of claim 7, wherein the outputting of the recommended destination includes:
outputting a plurality of recommended destinations corresponding to a single mission vehicle together with visit time information when the number of mission vehicles is one; and
outputting a control signal so that the single mission vehicle visits each of the recommended destinations n times (where n is a natural number) based on the visit time information.

10. The method of claim 9, wherein the outputting of the plurality of recommended destinations corresponding to the single mission vehicle together with the visit time information includes:
generating destination groups by classifying the mission destinations by regional groups;
determining recommended destinations corresponding to the single mission vehicle for each destination group; and
outputting the recommended destinations determined for each destination group together with the visit time information.

11. The method of claim 7, wherein the outputting of the recommended destination includes:
assigning corresponding recommended destinations to each of a plurality of mission vehicles when the number of mission vehicles is plural; and
extracting visit patrol routes for each of the plurality of mission vehicles based on the assigned recommended destinations, and
the recommended destinations are assigned so as not to overlap each other between the plurality of mission vehicles.

12. The method of claim 11, wherein the assigning of the corresponding recommended destinations to each of the plurality of mission vehicles includes assigning the recommended destinations using management district information of each of the plurality of mission vehicles.

13. The method of claim 11, wherein the assigning of the corresponding recommended destinations to each of the plurality of mission vehicles includes assigning the recommended destinations using travel time information of each of the plurality of mission vehicles.

14. The method of claim 11, further comprising:
outputting a control signal so that a following vehicle mounted with a mobile sensor visits the recommended destination and measures the urban data while each mission vehicle visits the assigned recommended destination and performs the mission; and
determining whether or not each mission vehicle performs the mission at the assigned recommended destination based on whether or not a measured value of the urban data measured by the mobile sensor of the following vehicle is within a target range.

15. The method of claim 11, wherein the extracting of the visit patrol routes for each of the plurality of mission vehicles based on the assigned recommended destinations includes
extracting the visit patrol routes using at least one of a traffic congestion degree, whether or not an event has occurred, whether or not there is a high concentration of fine dust, and whether or not data collection missions are performed simultaneously.

16. The method of claim 7, wherein the outputting of the recommended destination includes:
configuring a plurality of features included in the urban data in a plurality of layers;
perform scaling on two or more layers selected from the plurality of layers;
outputting information on the recommended destination from a result of performing the artificial intelligence algorithm using the two or more layers on which the scaling is performed as inputs; and
generating a visit patrol route for the mission vehicle to move to the recommended destination using the information on the recommended destination.

17. The method of claim 16, further comprising:
obtaining scoring data by calculating a score for an environmental situation for each road using the plurality of layers; and
outputting a control signal so that the mission vehicle located in another region moves to the mission destination when it is decided that the number of mission vehicles located at the mission destination is less than a reference value based on the scoring data.

18. A computing apparatus comprising:
one or more processors;
a memory loading a computer program executed by the processor; and
a storage storing the computer program,
wherein the computer program includes instructions for performing
an operation of collecting urban data measured on a road partitioned into a plurality of unit areas; and
an operation of generating a recommended destination for a mission vehicle based on the urban data and constraints set for performing a mission,
the recommended destination refers to one of the unit areas, and
the mission is any one of a plurality of predetermined types of missions performed by the mission vehicle on a mission area on the road including the recommended destination and one or more adjacent areas of the recommended destination.

19. The computing apparatus of claim 18, wherein the constraints include at least one of a mission performance time, whether or not start/end times are punctual, an urgency level, and whether or not departure/destination places match, and
the operation of generating the recommended destination for the mission vehicle includes an operation of outputting the recommended destination by applying the urban data and the constraints to an artificial intelligence algorithm.

20. The computing apparatus of claim 19, wherein the operation of outputting the recommended destination includes:
an operation of outputting a plurality of recommended destinations corresponding to a single mission vehicle together with visit order information when the number of mission vehicles is one; and
an operation of outputting a control signal so that the single mission vehicle continuously visits the plurality of recommended destinations based on the visit order information.
